(19) United States
(12) Patent Application Publication
(10) Pub. No.: US 2011/0182133 A1
(43) Pub. Date: Jul. 28, 2011

(54) EXTRUDER AND METHOD OF EXTRUDER OPERATION

(75) Inventor: Babu Padmanabhan, Bangalore (IN)

(73) Assignee: STEER ENGINEERING PRIVATE LIMITED, BANGALORE (IN)

(21) Appl. No.: 13/121,670

(22) PCT Filed: Dec. 24, 2008
(86) PCT No.: PCT/IN08/00861

§ 371 Date: Mar. 29, 2011

(30) Foreign Application Priority Data
Sep. 29, 2008 (IN) 2383/CH3/2008

(51) Int. Cl. B29B 7/60; B29B 7/46

(52) U.S. Cl. 366/76.6

(57) ABSTRACT

A method of extruder operation is described; the extruder comprising a housing having at least two cylindrical housing bores, each housing bore having an axis disposed parallel to the other axis and the first and second axes separated by a distance “a”; at least a first screw shaft and a second screw shaft being disposed in the first and second housing bores; the first and second screw shaft with a first and second screw respectively; the first and second screw each having an extruder diameter D and a screw root diameter d; the first and second screw shaft each having a volumetric ratio of at least 1.4 wherein the volumetric ratio is defined by the extruder diameter D divided by the screw root diameter d; at least two inlet hoppers in the vicinity of the housing bores and opening into said housing bore with at least one of the inlet hopper having a side inlet into the housing bore; the method comprising: feeding material to be processed through the at least two inlet hoppers into the housing bores; conveying the material through the extruder length from the inlet hoppers to the extruder outlet; driving each of said first and second screw shafts at a speed of at least 1000 rpm and at a torque density of at least 8.5 Nm/cm³; the torque density being the shaft torque at each first and second shaft divided by the third power of the distance ‘a’ of the first and second axes.

The invention relates to twin screw extruders and particularly to a method of operation of a twin screw extruder with shafts rotating in the same direction.

### BACKGROUND

Twin screw extruders having a feed opening at one end and a discharge opening at the other end are well known and extensively used for specific purposes of mixing materials which includes kneading, dispensing, homogenizing, distributing a material with or without increase in temperature or heat input in a continuous and controlled manner. Material is fed to the extruder by a hopper connected at the inlet and the extruder is typically operated on the so called ‘starve feeding’ methodology.

The material may consist of a single constituent or ingredient or multiple constituents in one phase or more phases. Some constituents may need to undergo phase transformation during processing. The work that is done by the extruder is the result of applications of forces that cause shearing action in various planes, compression, elongation and folding. It is desirable that these forces are applied uniformly on every particle or molecule only for a specific period of time in order to limit the work done as excessive work will cause fragile molecules to disintegrate resulting in a degraded product. The extent of work done is dependent on a number of factors including nature of the material being processed, amount of material that the extruder can receive as input at various ports, amount of torque available at any given speed, length of the extruder, and configuration of the extruder processing zone elements and components.

It is believed that an increase in shear rate enhances the quality of mixing and homogenization, though an increase in shear rate results in an increase in the specific energy requirements and temperatures. To balance this increase in the specific energy requirements and temperatures, it is essential to reduce the dwell time within the extruder and increase the through put. One approach has been the increasing of the volumetric ratio of the extruder and also by significantly increasing the minimum specific torque requirements. The volumetric ratio of an extruder is defined as the ratio of the extruder diameter [D] divided by the root diameter of the screw [d]. An increase in the volumetric ratio increases the fill capacity of the extruder though adversely affects the torque carrying capacity. The specific torque [T/a³] of an extruder refers to the ratio between the torque [T] and the third power of the center distance between the two axes [a] of the twin screw extruder. To increase the specific torque requirements a higher powered motor is required which requires corresponding strengthening of other components inside the gearbox and the torque transmitting system. The increase in volumetric ratio and specific torque requires various modifications involving a combination of design, materials, treatment and higher levels of safety.

### SUMMARY

The invention relates to a method of extruder operation; the extruder comprising a housing having at least two cylindrical housing bores, each housing bore having an axis disposed parallel to the other axis and the first and second axes separated by a distance “a”; at least a first screw shaft and a second screw shaft being disposed in the first and second housing bores; the first and second screw shaft being provided with a first and second screw respectively; the first and second screw each having an extruder diameter D and a screw root diameter d; the first and second screw shaft each having a volumetric ratio of at least 1.4 wherein the volumetric ratio is defined by the extruder diameter D divided by the screw root diameter d; at least two inlet hoppers being provided in the vicinity of the housing bores and opening into said housing bore with at least one of the inlet hopper having a side inlet into the housing bore; the method comprising: feeding material to be processed through the at least two inlet hoppers into the housing bores; conveying the material through the extruder length from the inlet hoppers to the extruder outlet; driving each of said first and second screw shafts at a speed of at least 1000 rpm and at a torque density of at least 8.5 Nm/cm³; the torque density defined by the shaft torque at each first and second shaft divided by the third power of the distance ‘a’ of the first and second axis.

The invention also relates to a method of extruder operation; the extruder comprising a housing having at least two cylindrical housing bores, each housing bore having an axis disposed parallel to the other axis and the first and second axes separated by a distance “a”; at least a first screw shaft and a second screw shaft being disposed in the first and second housing bores; the first and second screw shaft being provided with a first and second screw respectively, each screw including at least one element; the first and second screw each having an extruder diameter D and a screw root diameter d; the first and second screw shaft each having a volumetric ratio of at least 1.4 wherein the volumetric ratio is defined by the extruder diameter D divided by the screw root diameter d; a first intake element coupled to the first shaft and including a first flight, a second intake element coupled to the second shaft adjacent the first intake element and including a second flight, wherein the first flight and the second flight are adapted to co-operatively create a positive conveying effect to convey material when the first intake element and the second intake element are rotated in the same direction; at least two inlet hoppers being provided in the vicinity of the housing bores and opening into said housing bore with at least one of the inlet hopper having a side inlet into the housing bore; the method comprising: feeding material to be processed through the at least two inlet hoppers into the housing bores; conveying the material through the extruder length from the inlet hoppers to the extruder outlet; driving each of said first and second screw shafts at a speed of at least 1000 rpm and at a torque density of at least 8.5 Nm/cm³; the torque density defined by the shaft torque at each first and second shaft divided by the third power of the distance ‘a’ of the first and second axis.

### BRIEF DESCRIPTION OF ACCOMPANYING DRAWINGS

The accompanying drawings illustrate the preferred embodiments of the invention and together with the following detailed description serve to explain the principles of the invention.

FIG. 1 illustrates the geometry of a twin screw extruder with both shafts moving in the same direction.

FIG. 2 illustrates a plan view of a twin screw extruder in accordance with an embodiment of the invention.

FIG. 3: illustrate a side view of a twin-screw extruder in accordance with an embodiment of the invention.

FIG. 4: illustrates a cross sectional view of the twin screw elements that provide increased intake capacity, in accordance with an embodiment.

FIG. 5: illustrates the undercut formed by the flight of a screw element in accordance with an embodiment.

### DETAILED DESCRIPTION

In the following description, for purpose of explanation, numerous specific details are set forth in order to provide an understanding of the various embodiments. It will be evident, however, to one skilled in the art that the various embodiments may be practiced without these specific details. It will be appreciated that the various embodiments discussed herein may or may not be the same embodiment, and may be grouped into various other embodiments not explicitly disclosed herein.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

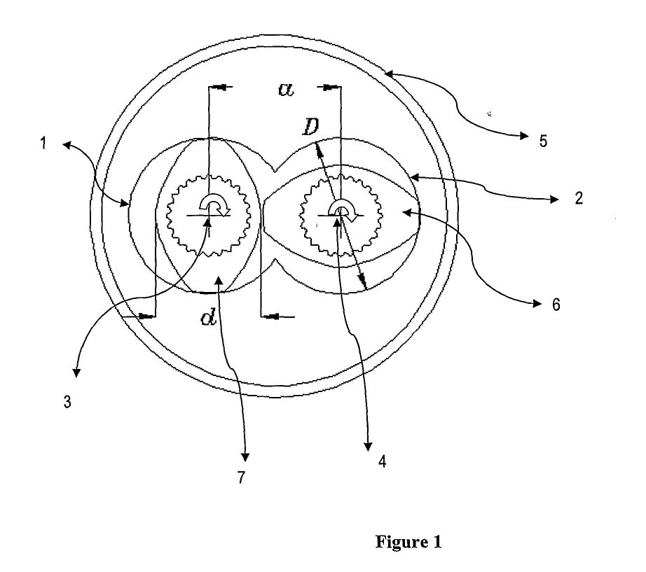

A method of extruder operation is disclosed for a twin screw extruder. With reference to FIG. 1, the cross section of the extruder as shown has housing (5) that includes two cylindrical housing bores (1, 2) having parallel axes (3, 4) respectively. Each bore houses a screw shaft that supports a screw (6, 7) that is formed of processing elements. The two shafts are placed parallel to each other with their centre distance between the axes ‘a’. Each element on one shaft while maintaining continuity with the adjacent element on the same shaft has a corresponding conjugate element on the other shaft.

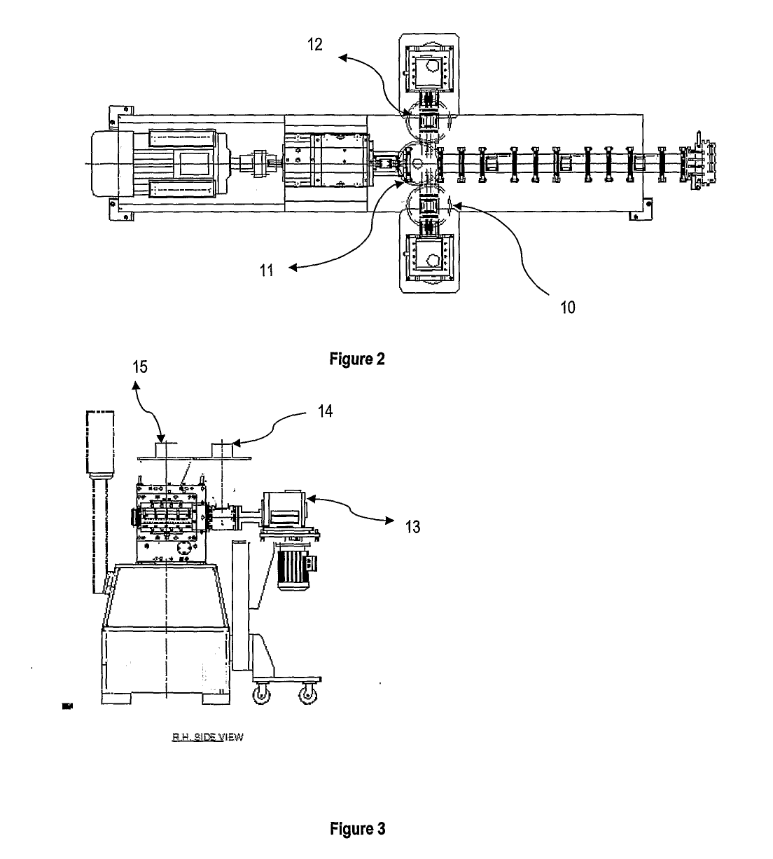

The extruder in accordance with an aspect of the invention has at least two hoppers for feeding material to the extruder. At least one side hopper is provided to feed additional material to the extruder. With reference to FIG. 2, the inlet of the extruder in accordance with an embodiment of the invention is illustrated having a plurality of hoppers (10, 11, and 12) for feeding material to the extruder. In the embodiment illustrated, the existing hopper (11) positioned vertically above the extruder at the inlet is supplemented with side hoppers (10 and 12). In accordance with another embodiment, the at least two hoppers may include hoppers (10, 12) both provided at the side of the extruder.

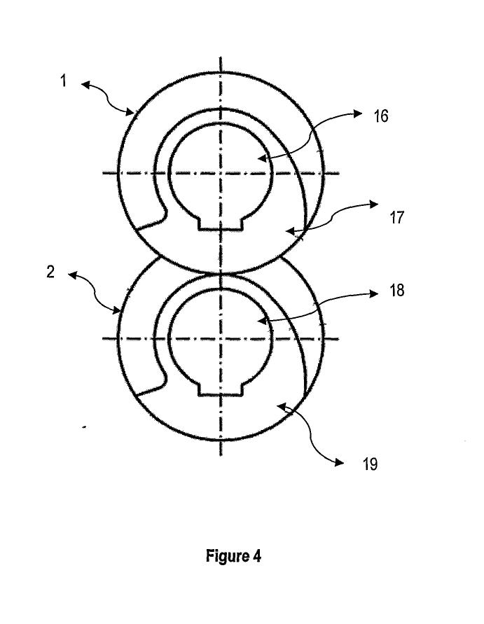

FIG. 3 illustrates an extruder in accordance with an embodiment having one side hopper (14) with force feeding means (13) that supplements the intake capacity of the hopper (15) for feeding material to the extruder.

In accordance with an embodiment, one hopper may be force fed while one hopper is gravity fed. Alternatively, both hoppers may be force fed to achieve the desired feed rate into the extruder. In the embodiment illustrated in FIG. 2, the side hoppers (10 and 12) are force feeding material to the extruder. The provision of the additional hopper and side inlets allows for a greater feed input into the same sized extruder.

The method of extruder operation provides for side feeding the extruder at least at the inlet end of the extruder. Side feeding the extruder at the inlet allows the extruder to run at the feed rate determined by the available torque in the extruder. The method of side feeding the extruder in the manner as described herein allows complete control over the amount of material that the extruder can receive at lower diameter ratios and lower specific torque levels.

The method of extruder operation as described requires the extruder to have a volumetric ratio of at least 1.4 wherein the volumetric ratio is defined by the extruder diameter D divided by the screw root diameter d. The extruder includes at least two inlet hoppers being provided in the vicinity of the housing bores and opening into said housing bore with at least one of the inlet hopper having a side inlet into the housing bore. Material is to be fed to the extruder through these hoppers including the at least one side hopper. The method also requires that each of said first and second screw shafts are driven at a speed of at least 1000 rpm and at a torque density of at least 8.5 Nm/cm³.

In accordance with another aspect of the invention, the extruder uses elements for the twin screws that provide a positive conveying effect.

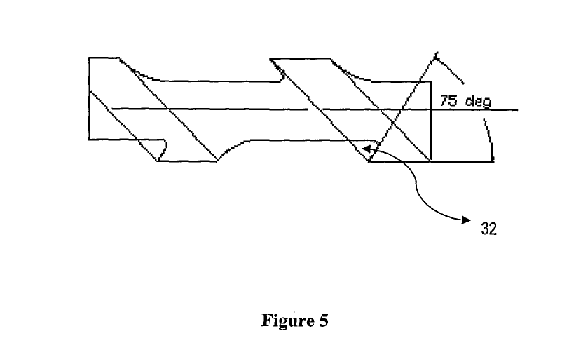

With reference to FIG. 4, an extruder in accordance with an embodiment is illustrated having two cylindrical housing bores (1, 2). The extruder includes a first shaft (16) and a second shaft (18) with a first intake element coupled to the first shaft and including a first flight (17) and a second intake element coupled to the second shaft and including a second flight (19).

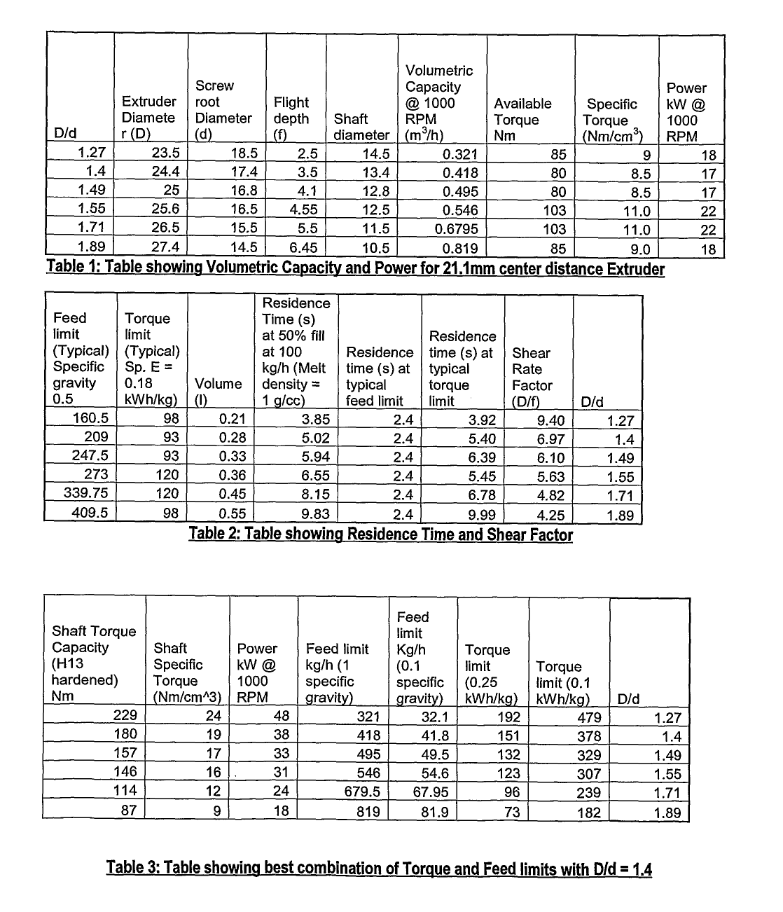

Undercuts (32) are defined by the flights (f) of the first and second elements as illustrated by FIG. 5. The first flight and the second flight both define an undercut. The undercut allows the intake elements to plough the material through the extruder system and create a positive conveying effect when run at or above a particular speed. The intake elements preferably have a single flight, but may alternatively have more than one flight. In an axial cross-section of the flights, the size and shape of the undercut preferably makes an acute angle to the axis of the intake elements. Typically, single flight intake elements of conventional extruder systems have an angle of 90 degrees or higher under the flight of the intake element. The intake elements of the preferred embodiment, however, preferably have a less than 85 degree angle and more preferably a 75 degree angle to create the undercut.

The method of extrusion in accordance with an aspect requires elements as described above to be used in the extruder that is run at a speed of at least 1000 rpm. In addition the volumetric ratio of the extruder is at least 1.4 and the extruder is fed by at least one side inlet. This method of operation significantly reduces operating costs while providing the desired shear rates and through put.

A 21.1 mm center distance extruder with a number of D/d ratios ranging from 1.27 to 1.89 is studied for volumetric capacity and maximum possible power at prescribed specific torque, and results of the study are tabulated in Table 1. Based on this information, mean residence time is calculated at 50% degree of fill and the results of this calculation are tabulated in Table 2. Generally applications are torque limited and residence time is calculated for D/d=1.4 and 1.49 and compared with D/d=1.55 and 1.71. With an increased mean shear intensity (D/f), the residence time is comparable at lower specific torque.

By the use of special elements as explained in the previous section, further control over the extrusion can be achieved for extruder with D/d>1.4, by overcoming feed limitation as well as achieving higher torque limited outputs that substantially exceed outputs of D/d>1.5 extruders as shown in Table 3.

### INDUSTRIAL APPLICABILITY

The method provides for higher throughput machines with greater torque carrying capability. The method does not demand design restrictions and allows for smaller sized machines to deliver higher throughput without comprising on mixing efficiency, thereby providing reduction in floor space requirement and ease of operability. The elements as described above along with the additional side feeding overcome feed limitations of the extruder and allow for greater throughputs without requiring an increase in volumetric ratio or in the torque density requirements.

The method also allows to use extruders with the highest torque densities with specific torque of 17 Nm/cm³ and higher. As a result of this, higher outputs, a better product quality and better utilization of resources will result.

1.-8. (canceled)

9. A method of extruding material comprising:
providing an extruder comprising:
a housing having at least two cylindrical housing bores, each housing bore having an axis disposed parallel to the other axis and the first and second axes separated by a distance a;
at least a first screw shaft and a second screw shaft being disposed in the first and second housing bores, the first and second screw shaft being provided with a first and second screw respectively, the first and second screw each having an extruder diameter D and a screw root diameter d, the first and second screw shaft each having a volumetric ratio of at least 1.4, wherein the volumetric ratio is defined by the extruder diameter D divided by the screw root diameter d;
at least two inlet hoppers being provided in the vicinity of the housing bores and opening into said housing bore with at least one of the inlet hoppers having a side inlet that opens into the housing bore;
feeding material to be processed through the at least two inlet hoppers into the housing bores;
conveying the material through the extruder length from the inlet hoppers to the extruder outlet;
driving each of said first and second screw shafts at a speed of at least 1000 rpm and at a torque density of at least 8.5 Nm/cm³;
the torque density defined by the shaft torque at each first and second shaft divided by the third power of the distance a between the first and second axes.

10. A method as claimed in claim 9 wherein material is fed into the extruder from at least one side hopper.

11. A method as claimed in claim 10 wherein the material is force fed from the side hopper into the extruder.

12. A method as claimed in claim 9 wherein the extruder is operated at a torque density of at least 17 Nm/cm³.

13. A method of extruding material comprising:
providing an extruder comprising:
a housing having at least two cylindrical housing bores, each housing bore having an axis disposed parallel to the other axis and the first and second axes separated by a distance a;
at least a first screw shaft and a second screw shaft being disposed in the first and second housing bores, the first and second screw shaft being provided with a first and second screw respectively, each screw including at least one element, the first and second screw each having an extruder diameter D and a screw root diameter d, the first and second screw shaft each having a volumetric ratio of at least 1.4, wherein the volumetric ratio is defined by the extruder diameter D divided by the screw root diameter d;
a first intake element coupled to the first shaft and including a first flight, a second intake element coupled to the second shaft adjacent the first intake element and including a second flight, wherein the first flight and the second flight are adapted to co-operatively create a partial vacuum that acts as a positive displacement pump to convey material when the first intake element and the second intake element are rotated in the same direction;
at least two inlet hoppers being provided in the vicinity of the housing bores and opening into said housing bore with at least one of the inlet hoppers having a side inlet that opens into the housing bore;
feeding material to be processed through the at least two inlet hoppers into the housing bores;
conveying the material through the extruder length from the inlet hoppers to the extruder outlet;
driving each of said first and second screw shafts at a speed of at least 1000 rpm and at a torque density of at least 8.5 Nm/cm³;
the torque density defined by the shaft torque at each first and second shaft divided by the third power of the distance a between the first and second axes.

14. A method as claimed in claim 13 wherein the first flight and the second flight define an undercut.

15. A method as claimed in claim 14 wherein the undercut is less than 85 degrees.

16. A method as claimed in claim 14 wherein the extruder is operated at a torque density of at least 17 Nm/cm³.

17. An extruder comprising:
a housing having at least two cylindrical housing bores, each housing bore having an axis disposed parallel to the other axis and the first and second axes separated by a distance a;
at least a first screw shaft and a second screw shaft being disposed in the first and second housing bores;
the first and second screw shaft being provided with a first and second screw respectively;
the first and second screw each having an extruder diameter D and a screw root diameter d;
the first and second screw shaft each having a volumetric ratio of at least 1.4, wherein the volumetric ratio is defined by the extruder diameter D divided by the screw root diameter d; and
at least two inlet hoppers being provided in the vicinity of the housing bores and opening into said housing bore with at least one of the inlet hoppers having a side inlet that opens into the housing bore.
